(19) United States
(12) Patent Application Publication
(10) Pub. No.: US 2013/0019083 A1
(43) Pub. Date: Jan. 17, 2013

(54) Redundant Transactional Memory

(71) Applicants: Harold W. Cain, III, Hartsdale, NY (US); David M. Daly, Croton on Hudson, NY (US); Kattamuri Ekanadham, Mohegan Lake, NY (US); Michael C. Huang, Rochester, NY (US); Jose E. Moreira, Irvington, NY (US); Mauricio J. Serrano, Bronx, NY (US)

(72) Inventors: Harold W. Cain, III, Hartsdale, NY (US); David M. Daly, Croton on Hudson, NY (US); Kattamuri Ekanadham, Mohegan Lake, NY (US); Michael C. Huang, Rochester, NY (US); Jose E. Moreira, Irvington, NY (US); Mauricio J. Serrano, Bronx, NY (US)

(73) Assignee: International Business Machines Corporation, Armonk, NY (US)

(21) Appl. No.: 13/179,672

(22) Filed: Jul. 11, 2011

(51) Int. Cl. G06F 9/30

(52) U.S. Cl. 712/203; 712/E09.016

(57) ABSTRACT

A mechanism is provided for redundant execution of a set of instructions. A redundant execution begin (rbegin) instruction to be executed by a first hardware thread on the first processor is identified in the set of instructions. The set of instructions immediately after the rbegin instruction are executed on the first hardware thread and on a second hardware thread. Responsive to both the first processor and the second processor ending execution of the set of instructions, responsive to a first set of cache lines in a first speculative store matching a second set of cache lines in a second speculative store, and responsive to a first set of register states in a first status register matching a second set of register states in a second status register, dirty lines in the first speculative store are committed thereby committing a redundant transaction state to an architectural state.

### BACKGROUND

The present application relates generally to an improved data processing apparatus and method and more specifically to mechanisms for redundant execution of high-priority code.

Transient and permanent faults in processor cores lead to errors and failures. If a processor core is executing hypervisor code, the entire data processing system can crash. The errors in the processor cores may be masked to prevent data processing system failures through the use of redundant execution. Redundant execution allows the detection of the error and re-execution to prevent the error from causing a data processing system failure. In the past, redundant execution has been implemented using a lockstep design, in which two processor cores execute one instruction at a time and compare their results. There is both significant performance impact and design cost to running in lockstep that make operating in a lockstep mode impractical in many situations.

### SUMMARY

In one illustrative embodiment, a method, in a data processing system, is provided for redundant execution of a set of instructions. The illustrative embodiment identifies a redundant execution begin (rbegin) instruction in the set of instructions to be executed by a first hardware thread on the first processor. In the illustrative embodiment, the first processor and a second processor execute the set of instructions immediately after the rbegin instruction on the first hardware thread and on a second hardware thread. The illustrative embodiment compares a first set of cache lines in a first speculative store associated with the first processor to a second set of cache lines in a second speculative store associated with the second processor in response to both the first processor and the second processor ending execution of the set of instructions. The illustrative embodiment compares a first set of register states in a first status register associated with the first processor to a second set of register states in a second status register associated with the second processor. The illustrative embodiment then commits dirty lines in the first speculative store thereby committing a redundant transaction state to an architectural state in response to the first set of cache lines and the second set of cache lines matching and the first set of register states and the second set of register states matching.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 shows a block diagram of an example data processing system in which aspects of the illustrative embodiments may be implemented;

FIG. 3 depicts a functional block diagram of a mechanism for implementing redundant execution in accordance with an illustrative embodiment;

FIGS. 4A and 4B depict a flowchart of the operation performed in implementing redundant execution in accordance with an illustrative embodiment; and

FIGS. 5A and 5B depict a flowchart of the operation performed in an event of a speculative storage overflow in accordance with an illustrative embodiment.

### DETAILED DESCRIPTION

The illustrative embodiments provide a mechanism for implementing redundant execution that allows the redundant execution to be applied to selected pieces of high importance code with low overhead while allowing other pieces of code to be executed without redundancy and no overhead. In the illustrative embodiments, important pieces of code are labeled with redundant execution begin (rbegin) and redundant execution end (rend) instructions. The code between the rbegin and rend is a redundant transaction. When a processor core executes an rbegin instruction at a beginning of a redundant transaction, the processor core spawns a redundant copy of the code on another processor core. When the rend instruction is executed at the end of the redundant transaction, the two processor cores check to make sure they both performed the transactions identically, before committing any system state. If a difference is found, an error handler is invoked and the redundant transaction is retried.

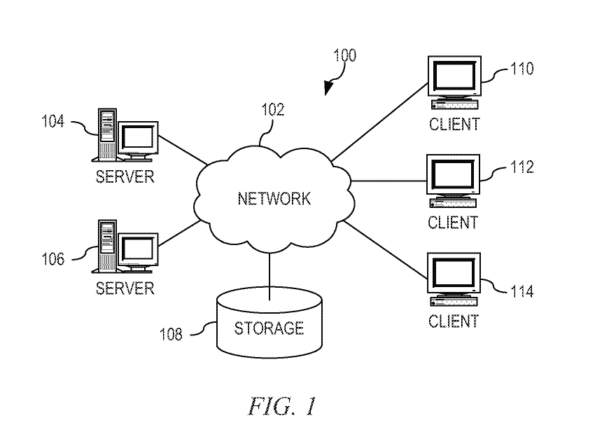

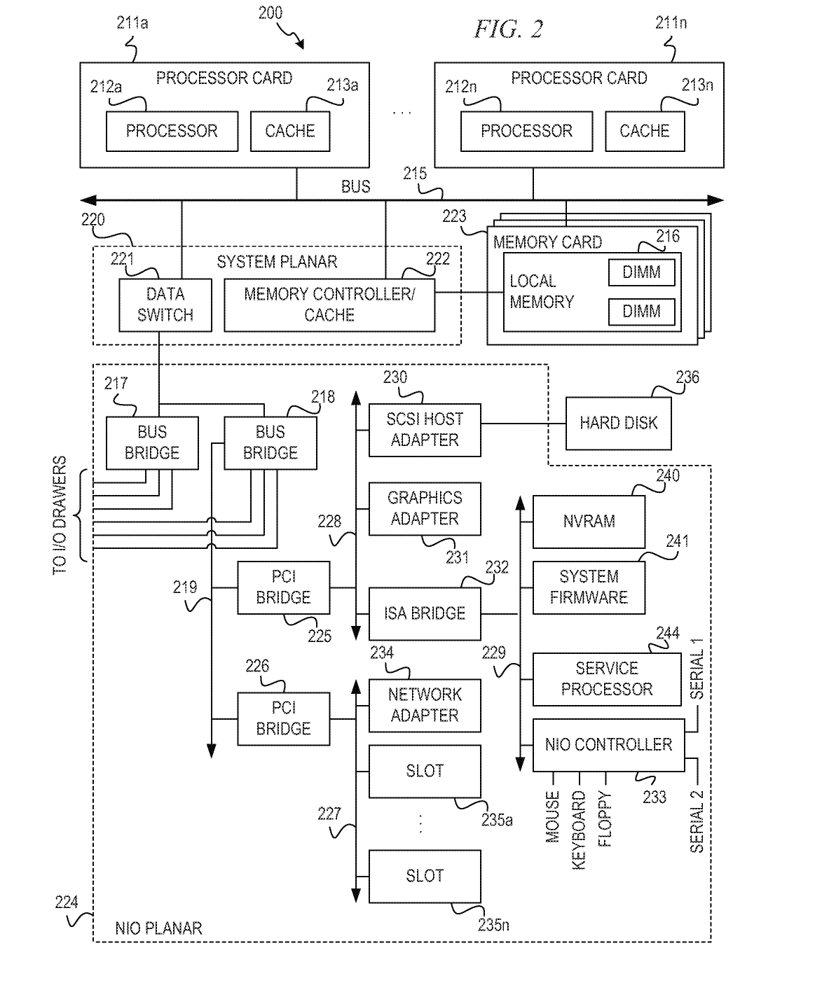

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an example data processing system is shown in which aspects of the illustrative embodiments may be implemented. Data processing system 200 is an example of a computer in which computer usable code or instructions implementing the processes for illustrative embodiments of the present invention may be located.

Referring now to the drawings and in particular to FIG. 2, there is depicted a block diagram of a data processing system with which aspects of the illustrative embodiments may advantageously be utilized. FIG. 2 is a more detailed block diagram of an SMP data processing system, which may be implemented as either the server computer system, such as server 104 and server 106 in FIG. 1, or a client computer system, such as client 110 in FIG. 1, in accordance with the present invention.

As shown, data processing system 200 includes processor cards 211a-211n. Each of processor cards 211a-211n includes a processor and a cache memory. For example, processor card 211a contains processor 212a and cache memory 213a, and processor card 211n contains processor 212n and cache memory 213n.

Processor cards 211a-211n are connected to main bus 215. Main bus 215 supports a system planar 220 that contains processor cards 211a-211n and memory cards 223. The system planar also contains data switch 221 and memory controller/cache 222. Memory controller/cache 222 supports memory cards 223 that include local memory 216 having multiple dual in-line memory modules (DIMMs).

Data switch 221 connects to bus bridge 217 and bus bridge 218 located within a native I/O (NIO) planar 224. As shown, bus bridge 218 connects to peripheral components interconnect (PCI) bridges 225 and 226 via system bus 219. PCI bridge 225 connects to a variety of I/O devices via PCI bus 228. As shown, hard disk 236 may be connected to PCI bus 228 via small computer system interface (SCSI) host adapter 230. A graphics adapter 231 may be directly or indirectly connected to PCI bus 228. PCI bridge 226 provides connections for external data streams through network adapter 234 and adapter card slots 235a-235r via PCI bus 227.

An industry standard architecture (ISA) bus 229 connects to PCI bus 228 via ISA bridge 232. ISA bridge 232 provides interconnection capabilities through NIO controller 233 having serial connections Serial 1 and Serial 2. A floppy drive connection, keyboard connection, and mouse connection are provided by NIO controller 233 to allow data processing system 200 to accept data input from a user via a corresponding input device. In addition, non-volatile RAM (NVRAM) 240 provides a non-volatile memory for preserving certain types of data from system disruptions or system failures, such as power supply problems. A system firmware 241 is also connected to ISA bus 229 for implementing the initial Basic Input/Output System (BIOS) functions. A service processor 244 connects to ISA bus 229 to provide functionality for system diagnostics or system servicing.

The operating system (OS) is stored on hard disk 236, which may also provide storage for additional application software for execution by data processing system. NVRAM 240 is used to store system variables and error information for field replaceable unit (FRU) isolation. During system startup, the bootstrap program loads the operating system and initiates execution of the operating system. To load the operating system, the bootstrap program first locates an operating system kernel type from hard disk 236, loads the OS into memory, and jumps to an initial address provided by the operating system kernel. Typically, the operating system is loaded into random-access memory (RAM) within the data processing system. Once loaded and initialized, the operating system controls the execution of programs and may provide services such as resource allocation, scheduling, input/output control, and data management.

The illustrative embodiment may be embodied in a variety of data processing systems utilizing a number of different hardware configurations and software such as bootstrap programs and operating systems. The data processing system 200 may be, for example, a stand-alone system or part of a network such as a local-area network (LAN) or a wide-area network (WAN).

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

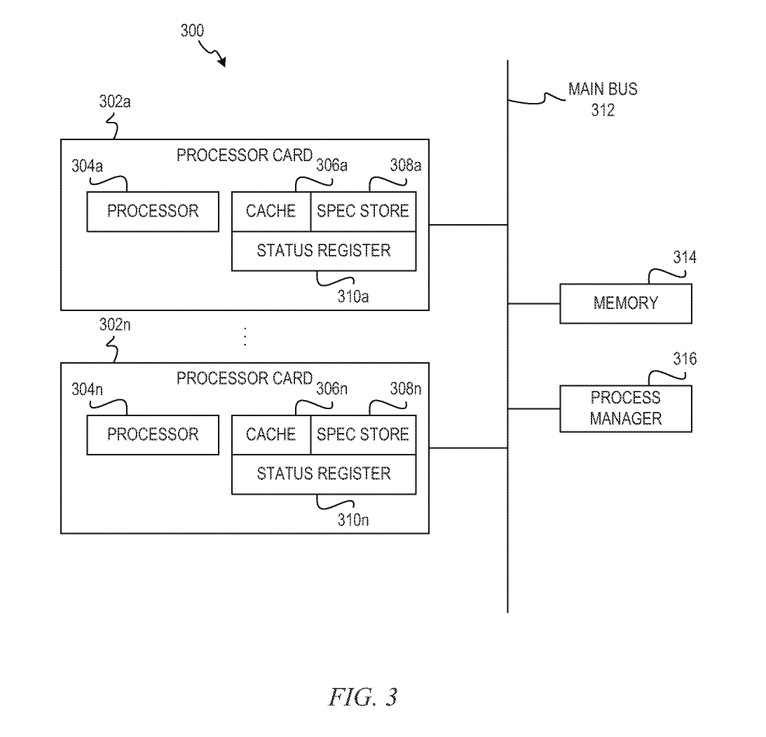

FIG. 3 depicts a functional block diagram of a mechanism for implementing redundant execution in accordance with an illustrative embodiment. Data processing system 300 comprises processor cards 302a-302n. Each of processor cards 302a-302n comprises a processor, a cache memory, a speculative store, and a status register. The speculative store can be implemented as a separate storage structure, or it could be embedded in the cache memory by adding a speculative bit to each line in the cache memory. For example, processor card 302a comprises processor 304a, cache memory 306a, speculative store 308a, and status register 310a, and processor card 302n comprises processor 304n, cache memory 306n, speculative store 308n, and status register 310n. Processor cards 302a-302n are connected to main bus 312.

During operation, instructions may be executed by processors 304a-304n on processor cards 302a-302n. In the illustrative embodiments, redundant execution is applied to selected pieces of high importance code through the use of labels. That is, selected pieces of high importance code are labeled with redundant execution begin (rbegin) and redundant execution end (rend) instructions. Code that does not require redundant execution is not labeled with redundant execution begin (rbegin) and redundant execution end (rend) instructions. When, for example processor 304a receives a request to execute a set of instructions in memory 314 that have an rbegin instruction thereby forming a redundant transaction, processor sends a request to process manager 316, such as a service processor, hypervisor, virtualization manager, or the like, via main bus 312 in order to acquire a hardware thread on, for example, processor 304n.

With a hardware thread acquired on processor 304n, process manager 316 generates a checkpoint of the current hardware thread state (register state) on both processors 304a and 304n to be able to roll back to in case of an error and then copies the current hardware thread state on processor 304a to the hardware thread on processor 304n. Alternatively, in a preferred embodiment, the checkpoint on processor 304n may be taken after copying the current hardware thread state on processor 304a to the hardware thread on processor 304n. Processors 304a and 304n then zero their respective hardware thread redundant transaction instruction count in status registers 310a and 310n. Processors 304a and 304n also may evict some of the dirty lines in the cache memory so that recovery from speculative state is easier, in the case that cache lines have speculative bits. Dirty lines are lines in the cache memory that have modified data. That is, the processor has stored data to the cache and the modified data has not been written back to the memory subsystem yet, thus making that data to be considered dirty. Processors 304a and 304n then begin executing the same code from memory 314 immediately after the rbegin instruction. Any stores issued by the hardware threads on processors 304a and 304n are allocated into speculative stores 308a and 308n, respectively, with a bit indicating the line is dirty from a redundant transaction. Processors 304a and 304n keep any changes made by a redundant transaction in speculative stores 308a and 308n, respectively, where they are isolated from other threads and each other.

If another hardware thread on another processor, other than processors 304a and 304n, performs a memory access that conflicts with the footprint of one or both of the redundant hardware threads on processors 304a and 304n, processors 304a and 304n abort the redundant transaction and process manager 316 invokes error handling. When a hardware thread on processor 304a or 304n reaches the rend (explicit rend) in the set of instruction associated with the redundant transaction, a hardware thread redundant transaction instruction count in status register 310a or 310n reaches the maximum instruction count (implicit rend), or a speculative storage overflow occurs (implicit rend), the hardware thread on processor 304a or 304n waits for the other hardware thread to also reach the rend (explicit rend), a hardware thread redundant transaction instruction count in status register 3100a or 310n reaches the maximum instruction count (implicit rend), or a speculative storage overflow occurs (implicit rend).

Once both hardware threads on processors 304a and 304n reach the explicit or implicit rend, process manager 316 compares speculative stores 308a and 308n, such that each line that was written by the redundant transactions is compared. Process manager 316 also compares the register states in status registers 310a and 310n to verify that all final state changes match up. If any lines differ between speculative stores 308a and 308n or any state changes differ between status registers 310a and 310n, processors 304a and 304n abort the redundant transaction and process manager 316 invokes error handling. Processors 304a and 304n further discard all dirty lines in speculative stores 308a and 308n, thereby undoing the effects of the redundant transaction. Status registers 310a and 310n contain the number of executed instructions and the reason for the abort (line difference, register difference, or the like).

If all lines in speculative stores 308a and 308n match and all state changes in status registers 310a and 310n match, processor 304a commits dirty lines in speculative stores 308a and processor 304n discards data associated with the redundant transaction from speculative stores 308n, thus committing the redundant transaction state to an architectural state. An architectural state is the status or value of all architected registers and other features (e.g., program counter) in a processor. Processor 304a adjusts the dirty cache lines' coherence state in status register 310a, if necessary, in order to not violate the global coherence protocol. Process manager 316 then releases processor 304n.

If the redundant transaction ended with an implicit rend based on a hardware thread redundant transaction instruction count in status registers 310a or 310n reaching the maximum instruction count or its speculative store becoming full or almost full, for the code that has been executed up to this point where implicit rend occurs, process manager 316 compares speculative stores 308a and 308n such that each line that was written by the redundant transactions is compared as well as comparing the register states in status registers 310a and 310n to verify that all final state changes match up. If all lines in speculative stores 308a and 308n match and all state changes in status registers 310a and 310n match, processor 304a and 304n committing the state of the transaction at the implicit rend the architectural state. Processor 304a and 304n then release the old register checkpoints. Then process manager 316 issues an implicit rbegin and execution resumes by processors 304a and 304n, generating new register checkpoints for both processor 304a and 304n, committing any dirty data in speculative store 308a to cache, and zeroing their respective hardware thread redundant transaction instruction count in status registers 310a and 310n.

If during execution, there is a speculative storage overflow in, for example, speculative store 308a, processor 304a pauses execution of the redundant transaction. The speculative storage overflow could be triggered by a real storage overflow (capacity storage for speculative storage has been exceeded), or by a prediction that speculative storage overflow could happen in the near future. For example, if the cache is 8-way associative and 7 lines out of a 8 ways for a particular set, have reached the “speculative” bit, then a prediction could be made that overflow will happen in the near future. Processor 304a then queries the processor 304n to see if speculative store 308n has overflowed on the same instruction. If the two hardware threads on processors 304a and 304n paused on the same instruction, then process manager 316 begins an implicit rend where process manager 316 compares speculative stores 308a and 308n, such that each line that was written by the redundant transactions is compared. Process manager 316 also compares the register states in status registers 310a and 310n to verify that all final state changes match up. If any lines differ between speculative stores 308a and 308n or any state changes differ between status registers 310a and 310n, processors 304a and 304n abort the redundant transaction and process manager 316 invokes error handling. Processors 304a and 304n further discard all dirty lines in speculative stores 308a and 308n, thereby undoing the effects of the redundant transaction. Status registers 310a and 310n contain the number of executed instructions and the reason for the abort (line difference, register difference, or the like).

If all lines in speculative stores 308a and 308n match and all state changes in status registers 310a and 310n match, processor 304a and 304n commit the state of the transaction at the implicit rend to the architectural state. Processor 304a and 304n then release the old register checkpoints. Process manager 316 issues an implicit rbegin and execution resumes by processors 304a and 304n generating new register checkpoints for both processor 304a and 304n, committing any dirty data in speculative store 308a to cache, and zeroing their respective hardware thread redundant transaction instruction count in status registers 310a and 310n.

If the two hardware threads did not pause on the same instruction, processor 304a writes status register 310a indicating a speculative storage overflow and the number of instructions its hardware thread executed, and processor 304n writes status register 31 in indicating a speculative storage overflow and the number of instructions its hardware thread executed. Process manager 316 then invokes error handling.

During the execution of a redundant transaction, other errors may also be encountered, such as encountering a non-deterministic operation, thread non-determinism, or the like. A non-determinism operation occurs when repeated execution of specific code generates different results. There are two possible causes of non-determinism. A first cause may be non-determinism within the thread, such as accessing a random number generator that is non-deterministic, where every execution gets a different result. This is called this “thread non-determinism.” A second cause may be non-determinism from interaction between the thread and the rest of the system. This occurs when the timing between the system and the thread may lead to different results. This is called “system non-determinism.” Ideally there should be no thread non-determinism within a redundant transaction. If thread non-determinism occurs, process manager 316 invokes error handling. System non-determinism cannot be completely avoided, and must be handled gracefully.

If the hardware thread in processors 304a or 304n attempts to execute a non-deterministic instruction (e.g., accessing the time base or random number generator), processors 304a and 304n execute an implicit rend before the non-deterministic instruction, write status registers 310a and 310n indicating non-deterministic instruction, and process manager 316 invokes error handling.

By process manager 316 invoking error handling, the error handler must handle failures for storage overflow, permanent faults, transient faults, thread non-determinism, and system non-determinism. The error handler knows if a storage overflow does or does not occur. The error handler may also know that a thread non-determinism event has occurred via status register. If an error occurs that is not a storage overflow or explicit thread non-determinism, the error handler does not know which kind of failure occurred. The error handler may implement one of the following steps:
1. Re-execute the redundant transaction (to cover transient faults).
2. Re-execute the redundant transaction with a smaller number of maximum instructions (for storage overflow or dealing with system non-determinism).
3. Run processor diagnostics to try to identify faulty hardware.
4. Re-execute the redundant transaction on different processor cores.
5. Invoke a system checkstop, such that process manager 316 identifies that instruction execution cannot continue correctly, thus stopping execution and collecting error information.
6. Execute some number of instructions non-redundantly (for non-determrninistic operation).
   Techniques 1 and 2 may be used for errors such as storage overflow errors, transient faults, and system non-determinism. Technique 6 may be used for dealing with thread non-determinism. The error handler has flexibility in deciding which technique to use for a given error. Overall system priorities and design may affect the decision.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

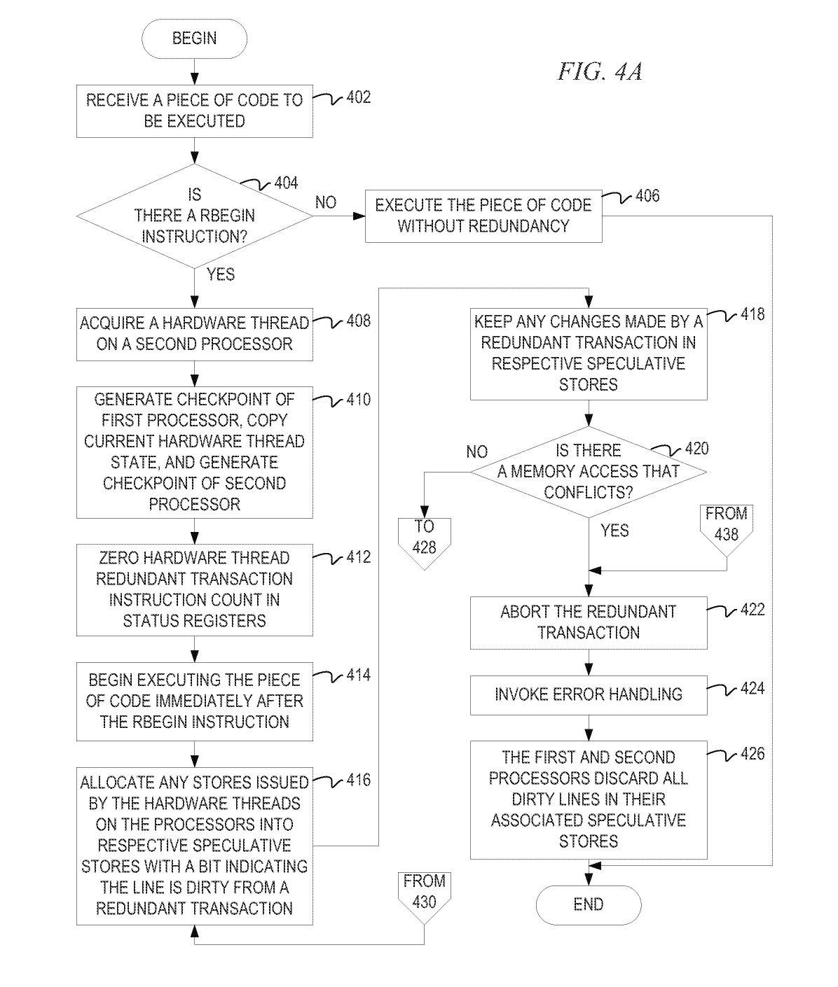

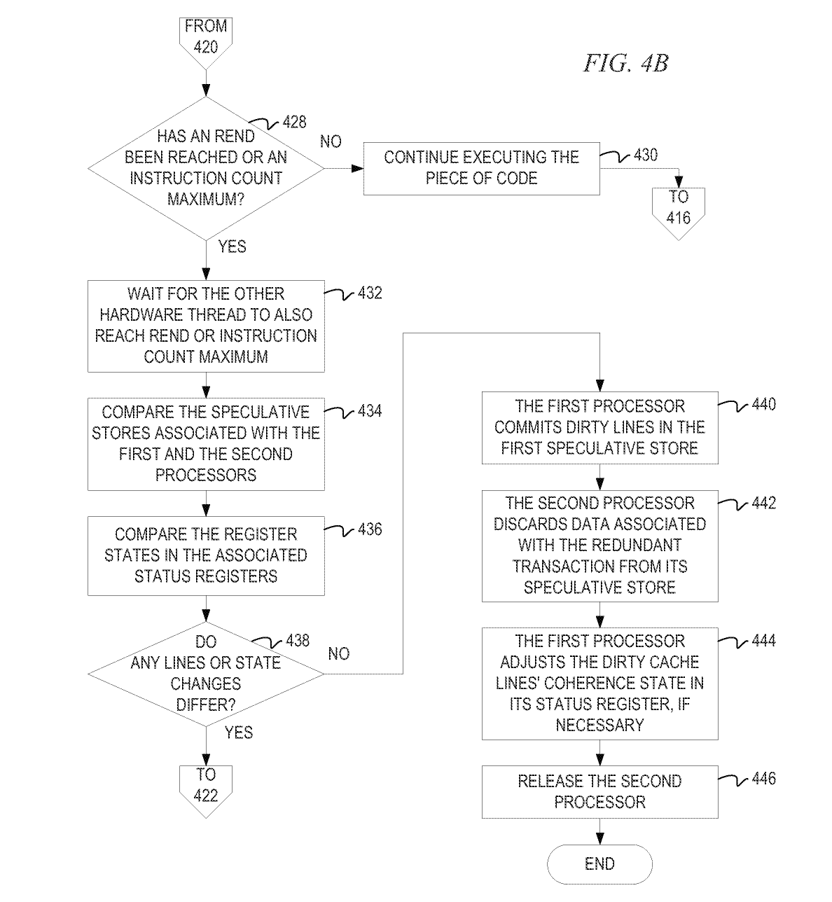

FIGS. 4A and 4B depict a flowchart of the operation performed in implementing redundant execution in accordance with an illustrative embodiment. As the operation begins, a first processor receives a piece of code to be executed (step 402). The first processor scans the piece of code to determine whether there is a redundant execution begin (rbegin) instruction (step 404). If at step 404 a redundant execution begin (rbegin) instruction fails to exist within the piece of code, then the first processor executes the piece of code without redundancy (step 406), with the operation terminating thereafter.

If at step 404 a redundant execution begin (rbegin) instruction exists thus forming a redundant transaction, then the first processor sends a request to a process manager in order to acquire a hardware thread on a second processor (step 408). Once the hardware thread is acquired on the second processor, the process manager generates a checkpoint of the current hardware thread state of the first processor (register state) to be able to roll back to in case an error copies the current hardware thread state on the first processor to the hardware thread on the second processor as well as generates a checkpoint of the second processor after copying the current hardware thread state of the first processor to the hardware thread of the second processor (step 410). Both processors then zero their respective hardware thread redundant transaction instruction count in their respective status registers (step 412). The processors then begin executing the piece of code immediately after the rbegin instruction (step 414). The processors allocate any stores issued by the hardware threads on the processors into respective speculative stores (step 416). A bit indicating the line is dirty from the redundant transaction may be included only if the speculative store is implemented as part of the existing cache. The processors keep any changes made by a redundant transaction in respective speculative stores where they are isolated from other threads and each other (step 418).

A determination is then made as to whether another hardware thread on another processor performs a memory access that conflicts with the footprint of one or both of the redundant hardware threads on the first and second processors (step 420). If at step 420 another hardware thread on another processor performs a memory access that conflicts with the footprint of one or both of the redundant hardware threads on the first and second processors, the first and second processors abort the redundant transaction (step 422), the process manager invokes error handling (step 424), and the first and second processors discard all dirty lines in their associated speculative stores, thereby undoing the effects of the redundant transaction (step 426), with the operation terminating thereafter.

If at step 420 another hardware thread on another processor fails to perform a memory access that conflicts with the footprint of one or both of the redundant hardware threads on the first and second processors, then a determination is made as to whether a hardware thread on the first processor or the second processor reaches the rend (explicit rend) in the set of instructions associated with the redundant transaction or a hardware thread redundant transaction instruction count in an associated status register reaches the maximum instruction count (implicit rend) (step 428). If at step 428 a hardware thread on the first processor or the second processor fails to reach the rend (explicit rend) in the set of instruction associated with the redundant transaction and a hardware thread redundant transaction instruction count in an associated status register fails to reaches the maximum instruction count (implicit rend), then the processors continue executing the piece of code (step 430) with the operation returning to step 416.

If at step 428 a hardware thread on the first processor or the second processor reaches the rend (explicit rend) in the set of instructions associated with the redundant transaction or a hardware thread redundant transaction instruction count in an associated status register reaches the maximum instruction count (implicit rend), then the first processor or the second processor waits for the other hardware thread to also reach the rend or its hardware thread redundant transaction instruction count in its respective status register to reach the maximum instruction count (step 432). Once both hardware threads on the first and the second processors reach the rend or the hardware thread redundant transaction instruction count in their respective status registers reach the maximum instruction count, the process manager compares the speculative stores associated with the first and the second processors, such that each line that was written by the redundant transactions is compared (step 434). The process manager also compares the register states in the associated status registers to verify that all final state changes match up (step 436).

The process manager determines whether any lines differ between the associated speculative stores or any state changes differ between the associated status registers (step 438). If at step 438 any lines differ between the associated speculative stores or any state changes differ between the associated status registers, then the operation proceeds to step 422. If at step 438 all lines in the associated speculative stores match and all state changes in the associated status registers match, the first processor commits dirty lines in the first speculative store thereby committing a redundant transaction state to an architectural state (step 440). The second processor discards data associated with the redundant transaction from its speculative store (step 442), thus committing the redundant transaction state to the architectural state. The first processor adjusts the dirty cache lines' coherence state in its status register, if necessary, in order to not violate the global coherence protocol (step 444). The process manager then releases the second processor (step 446), with the operation terminating thereafter.

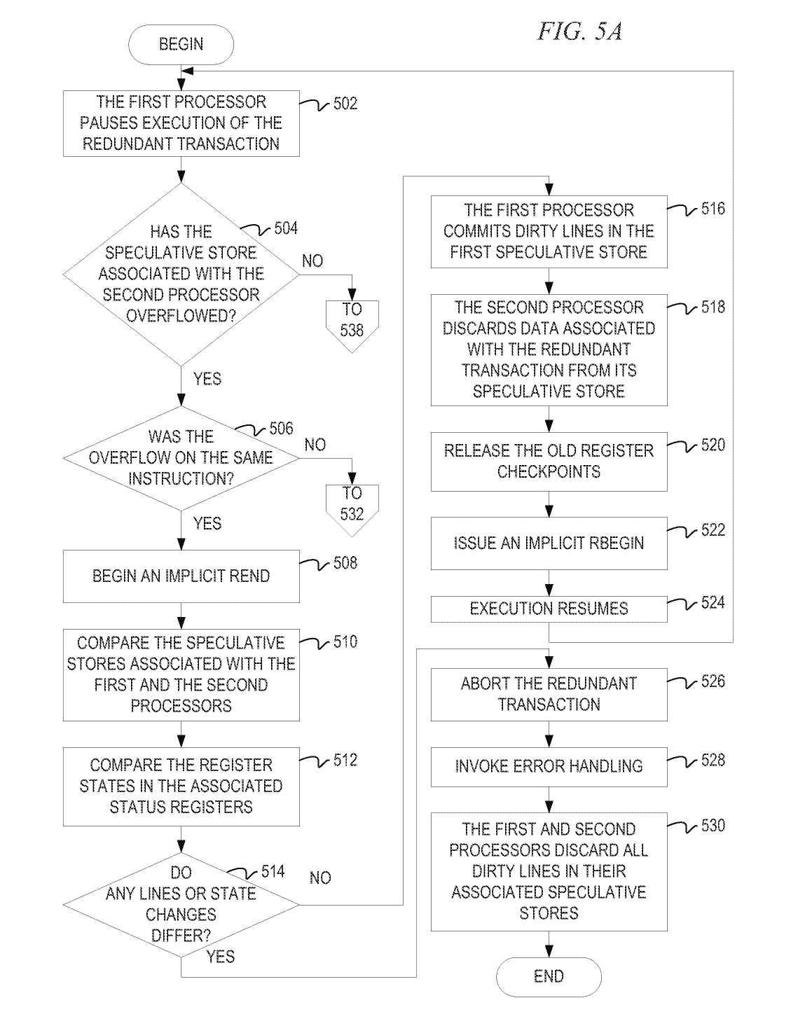

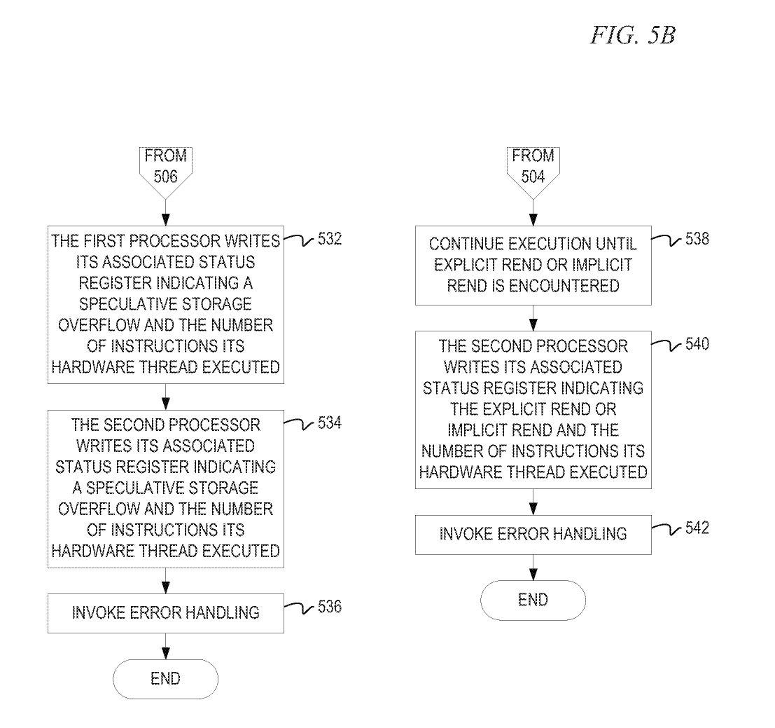

FIGS. 5A and 5B depict a flowchart of the operation performed in an event of a speculative storage overflow in accordance with an illustrative embodiment. During the operation described in FIGS. 4A and 4B, if a speculative storage overflow event is encountered in, for example, a speculative store associated with the first processor, then as the operation begins the first processor pauses execution of the redundant transaction (step 502). The first processor then queries the second processor to determine whether the speculative store associated with the second processor has overflowed (step 504). If at step 504 the speculative store associated with the second processor has overflowed, then the first processor queries the second processor to determine whether the speculative store associated with the second processor has overflowed on the same instruction (step 506). If at step 506 the two hardware threads on the first and the second processors paused on the same instruction, then the process manager begins an implicit rend (step 508). The process manager then compares the associated speculative stores, such that each line that was written by the redundant transactions is compared (step 510), and compares the register states in the associated status registers to verify that all final state changes match up (step 512). The process manager determines whether any lines differ between the associated speculative stores or any state changes differ between the associated status registers (step 514). If at step 514 all lines in the associated speculative stores match and all state changes in the associated status registers match, the first processor commits dirty lines in the first speculative store thereby committing a redundant transaction state to an architectural state (step 516). The second processor discards data associated with the redundant transaction from its speculative store (step 518), thus committing the redundant transaction state to the architectural state. The first and second processors then release the old register checkpoints (step 520). The process manager then issues an implicit rbegin (step 522) and execution resumes (step 524) by the first and the second processors generating new register checkpoints for both processors, committing any dirty data in the respective speculative store to cache, and zeroing their respective hardware thread redundant transaction instruction count in the respective status register. The process then returns to step 502.

If at step 514 any lines differ between the associated speculative stores or any state changes differ between the associated status registers, the first and second processors abort the redundant transaction (step 526) and the process manager invokes error handling (step 528). The first and second processors further discard all dirty lines in the speculative stores (step 530), thereby undoing the effects of the redundant transaction with the operation terminating thereafter.

If at step 506 the two hardware threads did not pause on the same instruction, the first processor writes its associated status register indicating a speculative storage overflow and the number of instructions its hardware thread executed (step 532). The second processor writes its associated status register indicating a speculative storage overflow and the number of instructions its hardware thread executed (step 534). The process manager then invokes error handling (step 536), with the operation terminating thereafter.

If at step 504 the second processor did not encounter a speculative storage overflow, then the second processor would continue execution until the second processor reaches the rend (explicit rend) in the set of instruction associated with the redundant transaction or a hardware thread redundant transaction instruction count in an associated status register reaches the maximum instruction count (implicit rend) (step 538). Once the second processor encounters an explicit rend or an implicit rend, the second processor writes its associated status register indicating the explicit rend or implicit rend and the number of instructions its hardware thread executed (step 540). The process manager then invokes error handling (step 542), with the operation terminating thereafter.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for implementing redundant execution that allows the redundant execution to be applied to selected pieces of high importance code with low overhead while allowing other pieces of code to be executed without redundancy and no overhead. In the illustrative embodiments, important pieces of code are labeled with redundant execution begin (rbegin) and redundant execution end (rend) instructions. The code between the rbegin and rend is a redundant transaction. When a processor core executes an rbegin instruction at a beginning of a redundant transaction, the processor core spawns a redundant copy of the code on another processor core. When the rend instruction is executed at the end of the redundant transaction, the two processor cores check to make sure they both performed identically, before committing any system state. If a difference is found, error handler is invoked and the redundant transaction is retried.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for redundant execution of a set of instructions, the method comprising:
identifying, by a first processor, a redundant execution begin (rbegin) instruction to be executed by a first hardware thread on the first processor in the set of instructions;
executing, by the first processor and a second processor, the set of instructions immediately after the rbegin instruction on the first hardware thread and on a second hardware thread;
responsive to both the first processor and the second processor ending execution of the set of instructions, comparing, by a process manager, a first set of cache lines in a first speculative store associated with the first processor to a second set of cache lines in a second speculative store associated with the second processor;
comparing, by the process manager, a first set of register states in a first status register associated with the first processor to a second set of register states in a second status register associated with the second processor; and
responsive to the first set of cache lines and the second set of cache lines matching and the first set of register states and the second set of register states matching, committing, by the first processor, dirty lines in the first speculative store thereby committing a redundant transaction state to an architectural state.

2. The method of claim 1, further comprising:
discarding, by the second processor, all cache lines from the second speculative store; and
releasing, by the process manager, the second processor.

3. The method of claim 1, further comprising:
responsive to a difference between the first set of cache lines and the second set of cache lines or responsive to a difference between the first set of register states and the second set of register states, aborting, by the first processor and the second processor, the set of instructions;
invoking, by the process manager, error handling;
discarding, by the first processor, all dirty lines in the first speculative store associated with the first processor; and
discarding, by the second processor, all dirty lines in the second speculative store associated with the second processor.

4. The method of claim 1, wherein the first processor or the second processor ending execution of the set of instructions is enacted by reaching a redundant execution end (rend) in the set of instructions.

5. The method of claim 1, wherein the first processor or the second processor ending execution of the set of instructions is enacted by a hardware thread redundant transaction instruction count in an associated status register reaching a maximum instruction count.

6. The method of claim 1, wherein, prior to the second processor executing the set of instructions immediately after the rbegin instruction on the second hardware thread, the method further comprises:
acquiring, by a process manager, a second hardware thread on a second processor at a request of the first processor;
generating, by the process manager, a checkpoint of a hardware thread state of the first hardware thread;
copying, by the process manager, a hardware thread state of the first hardware thread to the second hardware thread;
zeroing, by the first processor, a first hardware thread redundant transaction instruction count in a first status register associated with the first processor; and
zeroing, by the second processor, a second hardware thread redundant transaction instruction count in a second status register associated with the second processor.

7. The method of claim 1, wherein the comparison steps are performed in response to another hardware thread on another processor failing to perform a memory access that conflicts with a footprint of the first hardware thread or the second hardware thread.

8. The method of claim 7, further comprising:
responsive to another hardware thread on another processor performing a memory access that conflicts with a footprint of the first hardware thread or the second hardware thread, aborting, by the first processor and the second processor, the set of instructions;
invoking, by the process manager, error handling;
discarding, by the first processor, all dirty lines in the first speculative store associated with the first processor; and
discarding, by the second processor, all dirty lines in the second speculative store associated with the second processor.

9. The method of claim 1, further comprising:
allocating, by the first processor, a store issued by the first hardware thread into the first speculative store associated with the first processor with a bit indicating the store is dirty from the set of instructions; and
allocating, by the second processor, a store issued by the second hardware thread into the second speculative store associated with the second processor with a bit indicating the store is dirty from the set of instructions.

10. The method of claim 1, further comprising:
keeping, by the first processor, changes made by the set of instructions in a first speculative store where the changes are isolated from other threads and the second processor; and
keeping, by the second processor, changes made by the set of instructions in a second speculative store where the changes are isolated from the other threads and the first processor.

11. A computer program product comprising a computer readable storage medium having a computer readable program stored therein, wherein the computer readable program, when executed on a computing device, causes the computing device to:
identify a redundant execution begin (rbegin) instruction in a set of instructions to be executed by a first hardware thread on the first processor in the set of instructions;
execute the set of instructions immediately after the rbegin instruction on the first hardware thread and on a second hardware thread by the first processor and a second processor;
responsive to both the first processor and the second processor ending execution of the set of instructions, compare a first set of cache lines in a first speculative store associated with the first processor to a second set of cache lines in a second speculative store associated with the second processor;
compare a first set of register states in a first status register associated with the first processor to a second set of register states in a second status register associated with the second processor; and
responsive to the first set of cache lines and the second set of cache lines matching and the first set of register states and the second set of register states matching, committing dirty lines in the first speculative store thereby committing a redundant transaction state to an architectural state.

12. The computer program product of claim 11, wherein the computer readable program further causes the computing device to:
discard all cache lines from the second speculative store; and
release the second processor.

13. The computer program product of claim 11, wherein the computer readable program further causes the computing device to:
responsive to a difference between the first set of cache lines and the second set of cache lines or responsive to a difference between the first set of register states and the second set of register states, abort the set of instructions;
invoke error handling;
discard all dirty lines in the first speculative store associated with the first processor; and
discard all dirty lines in the second speculative store associated with the second processor.

14. The computer program product of claim 11, wherein, prior to the second processor executing the set of instructions immediately after the rbegin instruction on the second hardware thread, the computer readable program further causes the computing device to:
acquire a second hardware thread on a second processor at a request of the first processor;
generate a checkpoint of a hardware thread state of the first hardware thread;
copy a hardware thread state of the first hardware thread to the second hardware thread;
zero a first hardware thread redundant transaction instruction count in a first status register associated with the first processor; and
zero a second hardware thread redundant transaction instruction count in a second status register associated with the second processor.

15. The computer program product of claim 11, wherein the comparison steps are performed in response to another hardware thread on another processor failing to perform a memory access that conflicts with a footprint of the first hardware thread or the second hardware thread.

16. The computer program product of claim 15, wherein the computer readable program further causes the computing device to:
responsive to another hardware thread on another processor performing a memory access that conflicts with a footprint of the first hardware thread or the second hardware thread, abort the set of instructions;
invoke error handling;
discard all dirty lines in the first speculative store associated with the first processor; and
discard all dirty lines in the second speculative store associated with the second processor.

17. An apparatus, comprising:
a processor; and
a memory coupled to the processor, wherein the memory comprises instructions which, when executed by the processor, cause the processor to:
identify a redundant execution begin (rbegin) instruction in a set of instructions to be executed by a first hardware thread on the first processor in the set of instructions;
execute the set of instructions immediately after the rbegin instruction on the first hardware thread and on a second hardware thread by the first processor and a second processor;
responsive to both the first processor and the second processor ending execution of the set of instructions, compare a first set of cache lines in a first speculative store associated with the first processor to a second set of cache lines in a second speculative store associated with the second processor;
compare a first set of register states in a first status register associated with the first processor to a second set of register states in a second status register associated with the second processor; and
responsive to the first set of cache lines and the second set of cache lines matching and the first set of register states and the second set of register states matching, committing dirty lines in the first speculative store thereby committing a redundant transaction state to an architectural state.

18. The apparatus of claim 17, wherein the instructions further cause the processor to:
discard all cache lines from the second speculative store; and
release the second processor.

19. The apparatus of claim 17, wherein the instructions further cause the processor to:
responsive to a difference between the first set of cache lines and the second set of cache lines or responsive to a difference between the first set of register states and the second set of register states, abort the set of instructions;
invoke error handling;
discard all dirty lines in the first speculative store associated with the first processor; and
discard all dirty lines in the second speculative store associated with the second processor.

20. The apparatus of claim 17, wherein, prior to the second processor executing the set of instructions immediately after the rbegin instruction on the second hardware thread, the instructions further cause the processor to:
acquire a second hardware thread on a second processor at a request of the first processor;
generate a checkpoint of a hardware thread state of the first hardware thread;
copy a hardware thread state of the first hardware thread to the second hardware thread;
zero a first hardware thread redundant transaction instruction count in a first status register associated with the first processor; and
zero a second hardware thread redundant transaction instruction count in a second status register associated with the second processor.

21. The apparatus of claim 17, wherein the comparison steps are performed in response to another hardware thread on another processor failing to perform a memory access that conflicts with a footprint of the first hardware thread or the second hardware thread.

22. The apparatus of claim 21, wherein the instructions further cause the processor to:
responsive to another hardware thread on another processor performing a memory access that conflicts with a footprint of the first hardware thread or the second hardware thread, abort the set of instructions;
invoke error handling;
discard all dirty lines in the first speculative store associated with the first processor; and
discard all dirty lines in the second speculative store associated with the second processor.
